(19) United States
(12) Patent Application Publication
(10) Pub. No.: US 2004/0157663 A1
(43) Pub. Date: Aug. 12, 2004

(54) Method and system for computer-based game

(76) Inventor: Johnsen Bjorn Gunnar, (US)

Correspondence Address: CHRISTIAN D. ABEL, ONSAGERS AS, POSTBOKS 6963 ST. OLAVS PLASS, NORWAY, N-0130, NO

(21) Appl. No.: 10/475,872

(22) PCT Filed: Apr. 29, 2002
(86) PCT No.: PCT/NO02/00163

(30) Foreign Application Priority Data
Apr. 30, 2001 (NO) 2001 2144

(51) Int. Cl. G06F 17/00

(52) U.S. Cl. 463/42

(57) ABSTRACT

A method and a game engine are described for supporting the implementation of a game with a plurality of players. The game engine is connected to or forms part of a central computer-based game system (1), which in turn is connected to a data network (3), thus enabling it to exchange information with client systems (4) employed by the participating players. The game engine is designed to be able to generate starting positions for a game, receive influences from the paticipating client systems (4), and to generate an outcome based on the total number of influences received for the various possible outcomes.

The present invention relates to a method and a system for supporting the implementation of a game with a plurality of participants, wherein the system is a computer-based system connected to a data network for communication with terminals employed by the respective participants. The system is arranged to permit the implementation of a game, which may involve an element of chance, but where the participants are enabled to influence these random results.

Traditional games of chance can generally be divided into two categories. First of all there are games that are based on the participants buying a raffle ticket, choosing a number or a combination of numbers, or in some other way betting on a possible result, where the result is determined after all the bets have been placed. Another type of game is that where the results are decided in advance by some tickets being defined as winning tickets while other tickets do not give any prizes, and it is decided immediately after purchase whether a given ticket yields a prize. This is accomplished by opening a closed ticket (quick lottery) by opening windows on the ticket, by removing an opaque coating that conceals information (scratch-off ticket) and the like. The common feature of these games is that they offer the player no opportunity of influencing the result. In more sophisticated games the player has the opportunity of employing more advanced systems, such as in lotto and roulette, but in principle the player still makes a bet that is linked to the probability of winning, and after the bet has been placed there are no more opportunities of influencing the game.

This is due primarily to the fact that it has not been technically possible to offer the participants an opportunity of influencing the outcome in a manner which is fair in the sense that all the participants have the same chances and which is practicable with regard to game material such as lottery tickets, equipment for generating the outcome of the game and so on.

The use of computers and data communication has altered this situation to a certain extent. For example, WO 00/25281 describes a method and a system for games where a plurality of players are connected to a host computer, which enables the players to participate in the same game. The system makes it technically possible to implement a game resembling traditional games based on scratch-off lottery tickets where the idea is to find three figures of the same value. The value of the respective squares is selected by the server without any influence from the participants. In contrast to traditional scratch-off lottery tickets, the system makes it possible for the participants to see which squares are disclosed on other participants' tickets as well as disclosing squares on other players' tickets instead of their own.

U.S. Pat. No. 5,899,810 describes a distributed game system for a plurality of participants. This system involves a so-called virtual world, and is primarily designed to overcome waiting time resulting from the distributed solutions. The publication is not concerned with technology related to implementation of games of chance.

The implementation of a game where several participants employ their own terminal each and are in communication with a central computer, or server, will require the solving of problems associated with distribution and processing of information, automatic registration of participants and their activities and so on. It will be necessary to transmit information concerning game coupons or other kinds of game layout or game boards to the participants while maintaining an overview thereof in the server. Furthermore, information has to be transmitted concerning the activities of the participants from the players' terminals to the server. This information has to be processed electronically in the server, and insofar as the activities of the respective participants influence the situation for other participants, information on this must be transmitted to their terminals.

An object of the present invention is therefore to provide a method and a system that make it possible to handle the large amounts of information, which have to be transmitted and processed in connection with this kind of implementation of a game, especially a game that is available to an almost unlimited number of participants and independent of their geographical position.

Furthermore, it is an object of the present invention to permit the participants' individual influence of the outcome of the game in a manner that is fair in the sense that each participant, independently, for example, of his or her geographical location, has the same opportunity for such influence and that other participants do not have knowledge of this influence apart from to the extent that it can be observed in the development or the outcome of the game.

A further object is to permit an automatic administration of the game in the form of entering the players' personal details, participant fees and bets.

These objects are achieved by means of the features indicated in the independent claims. The dependent claims indicate further features and advantageous embodiments.

In particular, the invention specifies a computer-implemented game engine in the form of a combination of software and hardware components in a central computer or a server, or possibly a combination of several computers that constitute a central computer system. This computer system is capable of receiving information from players and based on this information setting up player accounts, which preferably comprise a player number, the player's name and/or user name, password as well as personal information such as address, payment information, etc. Furthermore, the computer system is capable of generating game tickets or game boards. Depending on the game that has to be implemented, a common game board may exist for all the players or one or more game tickets for each individual player. Information associated with the game may consist of a combination of information that is available to all participants and information that is only available to the individual participant.

The computer system according to the invention will also comprise means for generating outcome or results (events) within the framework of the individual game. It will be possible for the participating players to influence these means by their paying to influence the outcome. Each individual player casts a number of votes in order to influence the result, and information on this is transmitted to the central computer system, where this influence is summed. The result of the influence can be used directly in order to generate an outcome, with the outcome that has received most votes becoming the final outcome, or the possible outcome can be given a probability, which is proportional to the number of votes.

The payment for being allowed to participate in influencing the outcome may be in the form of points within the means of calculation of points employed in the game, or it may be in the form of points deducted from the participant.

This will be a matter of implementation, which will be linked to the implementation of the individual game, and not to the invention as such.

The invention will now be described in greater detail in the form of embodiments, with reference to the attached drawings, in which

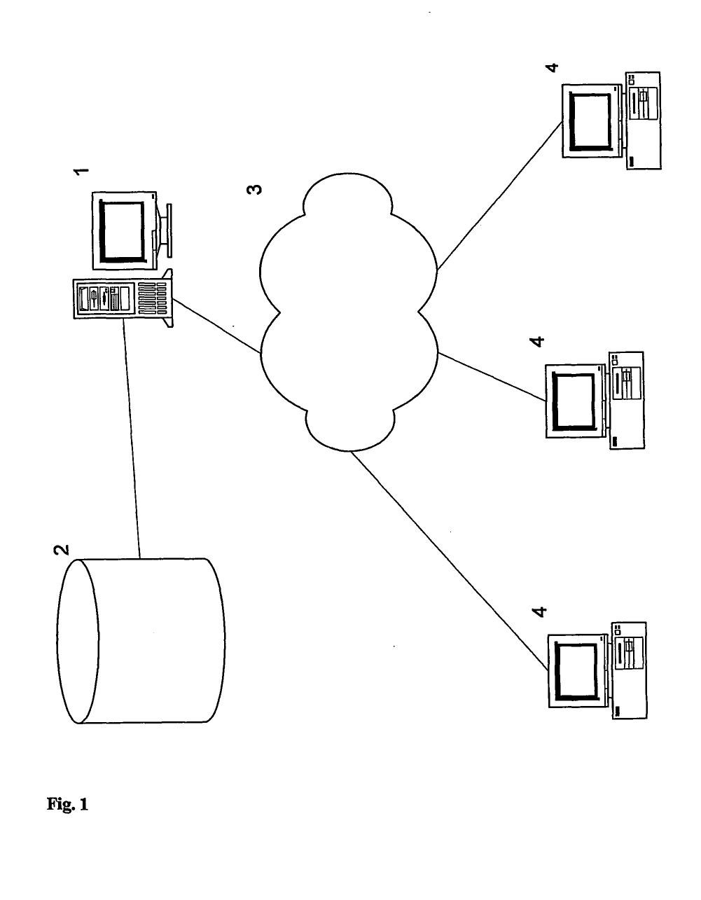

FIG. 1 illustrates a system according to the invention.

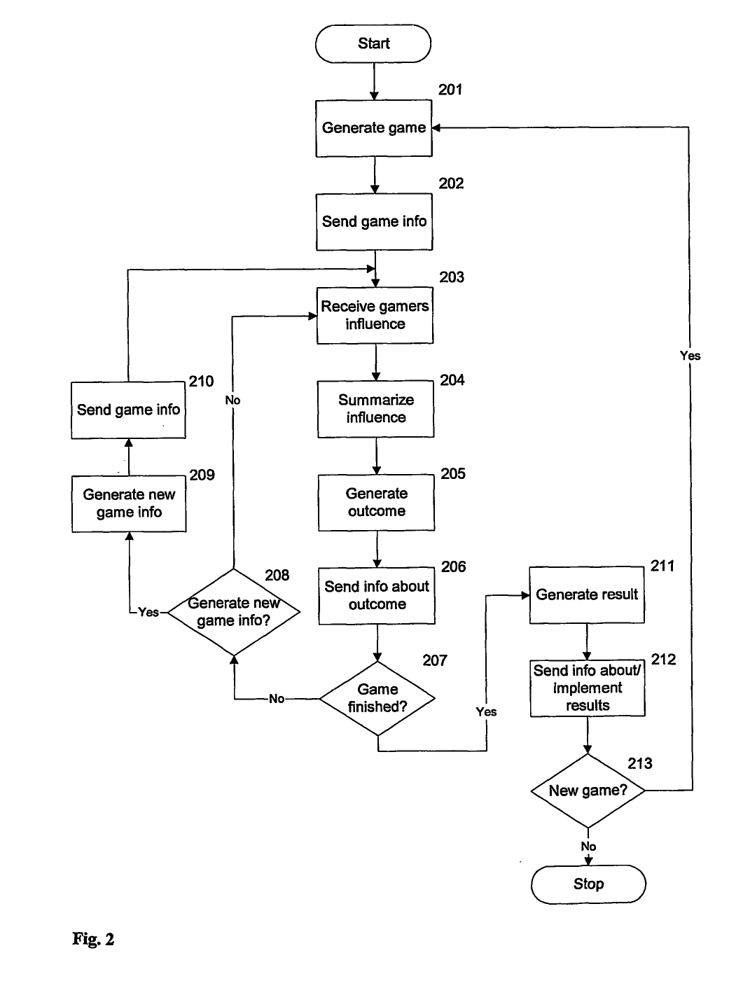

FIG. 2 is a flow chart illustrating the course of a method according to the invention for generating outcome.

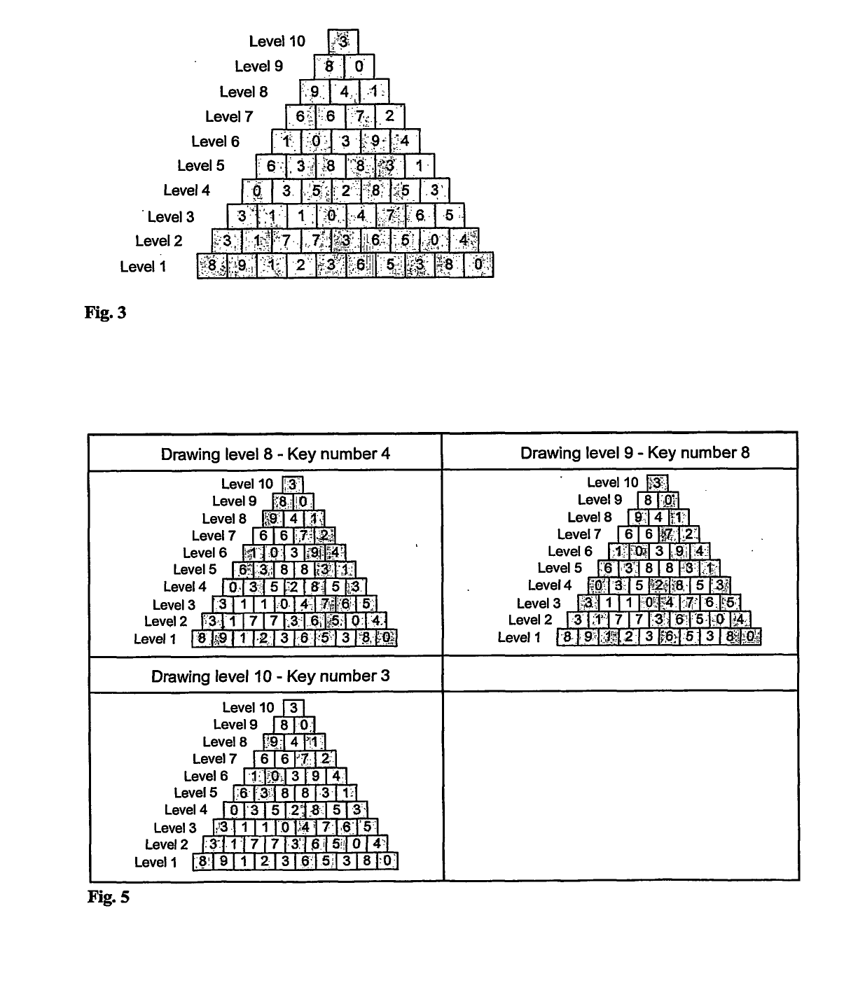

FIG. 3 illustrates a game ticket for a game that can be performed by means of the invention.

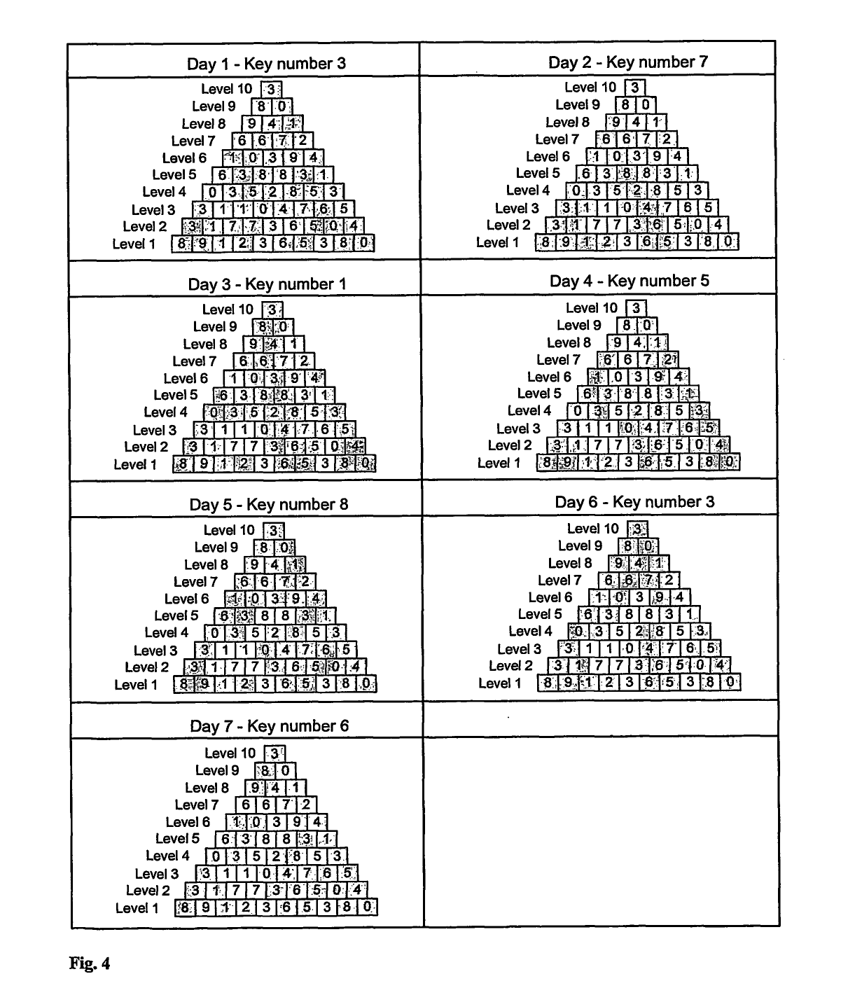

FIG. 4 illustrates the course of play in a game like that in FIG. 2.

FIG. 5 illustrates examples of drawing in the three last rounds in a game like that in FIG. 2.

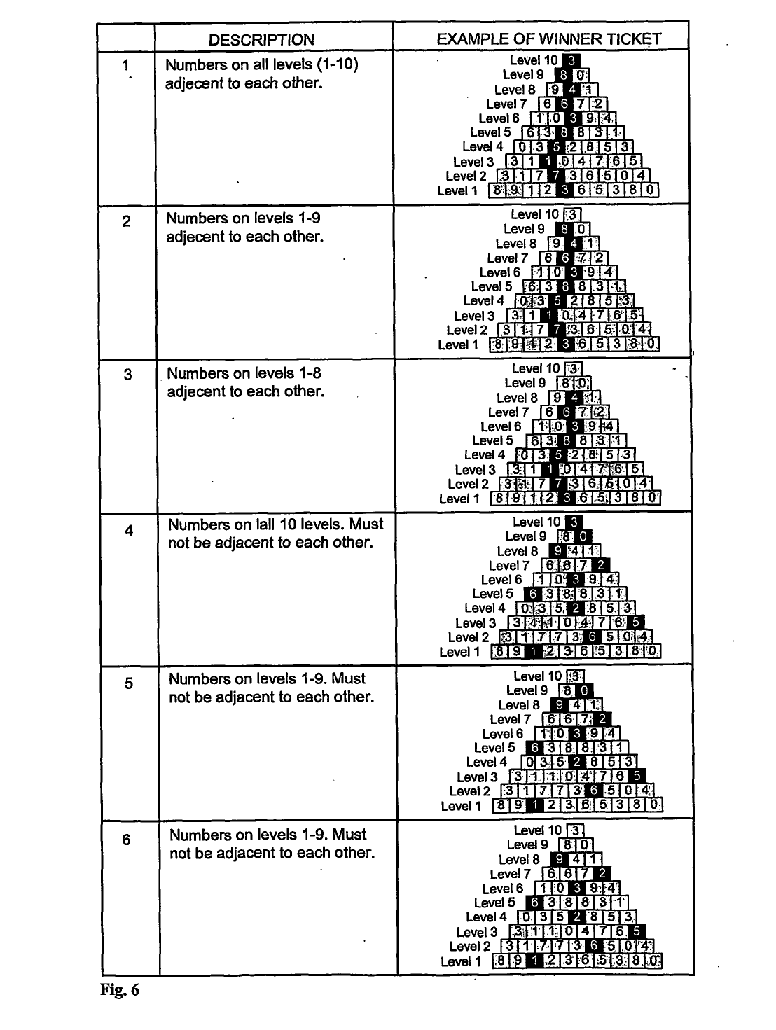

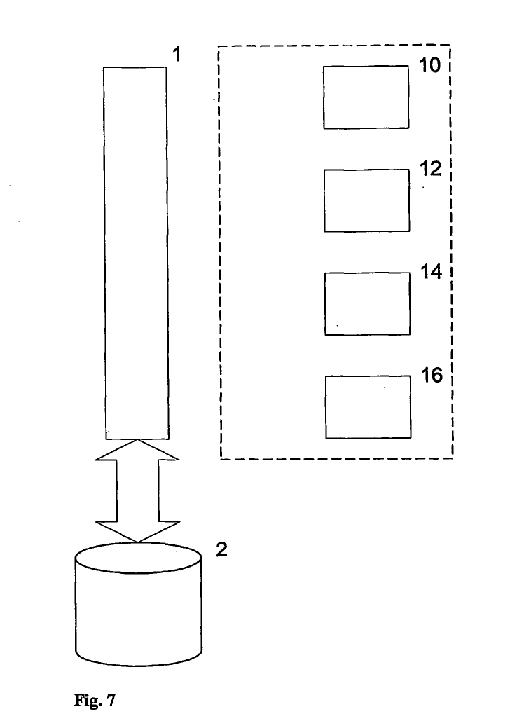

FIG. 6 illustrates examples of the combinations that give winnings 1 to 6 in a game like that in FIG. 2.

FIG. 7 illustrates modules in a game engine according to the invention.

In FIG. 1 a system is illustrated for implementing a game according to the invention. A central computer or server 1 is connected to a database 2 as well as to a communication network 3 such as, for example, the Internet. Each individual player is in communication with the server 1 by means of player terminals 4, which are also connected to the communication network 3. The player terminals 4 comprise software that acts as clients in relation to the server 1, for example in the form of an ordinary network reader or in the form of software specially designed to communicate with the server 1. The server comprises software that realises the game engine according to the invention, software for administering player information, software that implements the individual game, which utilises the game engine, together with software for accessing the database 2. The database comprises player information, as well as information associated with the individual game in cases where such information is particularly extensive.

FIG. 2 illustrates a flow chart depicting the course of a method for generating outcome in a game where the game engine according to the invention is employed. In a first step 201 the actual game is generated. The game per se is not a part of the invention, but examples of games where the game engine and the method according to the invention can be employed are described below. It is assumed that the participating players are already registered and that the relevant information about them exists in the database 2. After the game is generated, relevant information is sent to each individual player in a next step 202. This information may be in the form of game tickets or another kind of game board with given exit information. This information is also stored in the database 2 in a manner that links the game information to information on the individual players insofar as this is required by the game. This is preferably implemented by a database 2, which is a relational database.

In the following examples it will be assumed that the information is transmitted to the clients 4 in the form of HTML documents, possibly including Java script, Java applets or the like, but in principle this information will be able to be formatted in any way known to a person skilled in the art and considered to be suitable with regard to the implementation in question.

The information that is transmitted to the players will be displayed on the individual player's terminal 4 and each player can then attempt to influence the outcome of the game according to specific rules relevant to the individual game. According to the invention information will be transmitted from the player terminal 4 to the server 1 comprising information on the outcome desired by the player and a bet the player wishes to place in order to achieve this outcome. The player may indicate this, for example, by clicking with a mouse pointer a certain number of times on the outcome he wants, or the relevant information may be entered in a kind of game coupon on the player's screen and transmitted. In order to increase the security of the game, this information may be encrypted, thus preventing the individual player from finding out the choices and bets of the other players. This can be done in a great may ways that will be known to a person skilled in the art. For example, encryption algorithms may be employed that are linked to the use of so-called public key, private key. The information from the server to the player may also be encrypted in a similar manner.

The server receives the information from the respective players in a next step 203. For each player this information will comprise a desired outcome for the round together with a value representing the bet the player wishes to place in order to achieve this outcome. This influence is then summed in a subsequent step 204 by adding up how large a bet was placed in each of the respective possible outcomes. The game engine then generates the final outcome in a next step 205. The outcome may then simply be the outcome that achieved the highest result in the previous step, or these results may be used as weight for a random generator, with the result that an outcome that received, for example, 40% of the bets has a 40% probability of being the final outcome.

In a next step 206, information is transmitted concerning the outcome to the client systems 4. Depending on the game being implemented, it may be possible to keep this information concealed from the players, and it may also be retained in the game system 1 for the time being, and only transmitted to the clients 4, for example, at the conclusion of the game. Any results of the outcome are implemented, for example, by storing relevant additional information in the database 2 or modifying the game information that is already stored therein.

In a next step 207 a check is made as to whether the game is over or whether it will continue in the form of more rounds. If the game is to continue, a test is made in a next step 208 as to whether additional game information has to be generated. If so, this is carried out in a next step 209, and information on the new game information is transmitted to the participants 210 and to the database 2 to the extent that this is required by the game, before preparations are again made to receive new influences on the game from the players. After this the game engine is again ready to receive information from the individual players 203.

When, after a number of run-throughs of the routine described above, it is decided in step 207 that the game is over, final results 211 are generated, and information on this is sent to the participants 212. Measures may be initiated associated with the results, for example by entering points or prizes in accordance with the results of the game. A decision is then made as to whether a new game 213 should be started, and if so, the game engine returns to the step for generating the game 201.

We now refer to FIG. 3, which illustrates an example of a game that can be realised by means of the present invention. It should be understood that the game, which is produced by the inventor, is described herein only in order to illustrate the use of the game engine according to the invention, and that the scope of the invention is by no means limited by the rules associated with this specific game.

In FIG. 3 a game plan is illustrated in the form of squares placed in the form of a pyramid. In this embodiment there are ten squares on level 1, while the number of squares is reduced by one for each level, with the result that on the top level there is only one square. Each square contains a number, but the distribution of these numbers is random, and at the start of the game each player will be assigned one or more unique pyramids. These pyramids constitute the player's game tickets.

In the first round of the game a key number has to be generated for first level. This number is generated by all the players selecting a number from 0 to 9 and voting for this number. A player may well vote several times for the same number, and also spread his votes over several numbers. As long as the round is open, it is possible to increase one's number of votes for a given number or change strategy and begin to vote for a new number. Each vote costs a bet in the form of a total number of points or a sum of money. As long as the round is open, a continuous presentation will preferably be made of which number has received most votes, thus motivating the players to cast more votes, but it will also be possible to keep this secret until the round is over. When the round is over, the number that has received most votes will be the round's key number, and this will be indicated in each player's pyramid.

The subsequent rounds will proceed in the same manner, and the object is now for each round to have key figures in squares located above the previous round's key figure. FIG. 4 illustrates the development of a game through 6 rounds, where the key numbers for the respective rounds are 3, 7, 1, 5, 8, and 3 respectively. This embodiment of the game is intended to extend over seven days, thus enabling a new game to be arranged every week, and the three last rounds are therefore arranged by means of central drawing, and not by the participants voting for key numbers. In the three final rounds, the outcome generator is designed to generate a quasi-random outcome where the players cannot influence the outcome by voting for key numbers. The game's first prize is won by the formation of a path of key numbers, all of which are in contact with one another right up to the top of the pyramid, while other combinations give lesser prizes. FIG. 5 illustrates examples of drawing in the three final rounds. FIG. 6 illustrates the combinations that give the prizes 1 to 6. It will be appreciated that it is possible to have several winning combinations on one ticket if the key number appears several times on the respective levels, but a key number can only appear in one winner row.

We now refer to FIG. 7.

If a game such as, for example, that described above, has to be implemented over a large geographical area and with a large number of participants, a number of technical problems will arise that cannot be solved by the prior art. However, these technical problems will be overcome by means of the present invention. First of all, a game engine is required that is capable of generating a starting position for a given game. This is solved according to the present invention by means of a device 10 for generating starting positions for a game. Depending on the game that has to be implemented, these starting positions may be common to all the players, unique to all the players, or they may be generated individually for all the players, but without the need for them to be unique. In the example described above, it will be possible to employ both of the two last alternatives. The device 10 for generating these starting positions will at least comprise a generator for random numbers. This may also be designed in such a manner that it places these numbers in one or more forms representing game boards or coupons associated with the ongoing game and/or the respective players, but according to a preferred embodiment this is left to the game system 1 on the basis of the generated random numbers, since this will make it unnecessary to change or configure the game engine depending on which game has to be run. Moreover, it should be noted that the game engine and the rest of the game system 1 may be so closely integrated that it will not be an easy matter to indicate which parts are included in the game engine and which are a part of the rest of the game system.

In order to be able to administer a game with a large number of participants, the game engine according to the invention will comprise a device 12 for registering starting positions for an ongoing game. This device may be limited to transmitting generated information to the game system 1, which formats and stores this information, or the device 12 may handle information that is already formatted in forms or coupons by the generator 10 and may associate these with ongoing games or participating players.

The game system 1 will therefore either receive already formatted information from the registration device 12 or it will format it itself, and it will either receive information that is already associated with a given game or given players, or it has to make these connections itself, depending on the functionality of the game engine. In any case, the game system 1 will store the generated starting positions in a storage device 2. If each individual player has his/her starting position or set of starting positions, as will be the case in the example described above, each starting position, which for example represents a coupon, will be stored in a manner that links the given starting position to an individual player. This can be done in a number of ways, depending on how the storage device is designed, but may be implemented, for example, by means of a relational database where each starting position is stored in a table of starting positions, where these refer to a player in a table of players. There are a number of other possibilities, which will be obvious to those skilled in the art. If the starting position is common to all the players, and, for example, represents a game board where the respective players have different player positions, it will not be necessary to associate the starting position with the players, but instead it is the players' positions and how these change as a result of the game that have to be recorded.

In order to be able to realise a game comprising participants located over large geographical areas, it will be necessary to administer communication with the players in an efficient and secure manner. In a preferred embodiment the game system 1 will administer all communication with the players' client systems 4, with the result that the game engine only acts as a subsystem for the game system 1. The game engine, however, may also be designed to receive information directly from the clients 4.

The game engine according to the invention solves the problem of how to allow actions performed by players who may be scattered over a large geographical area to influence the outcome of each round of a game, while the actions of each individual player are kept concealed from the other players. This is accomplished by the fact that the game engine comprises a device 14 for receiving information concerning actions performed by the respective players and for generating an outcome representing a result for the ongoing round based on this information. How the actions influence the outcome will be dependent on the individual game that has to be implemented. A final number of possible outcomes will exist for each round, and each individual player indicates which outcome the player wishes as outcome of the round. In a preferred embodiment each player will be able to associate a weighting factor with the outcome he/she wants, for example by the player's bet representing how much weight is added for this outcome.

For example, the possible outcomes may be presented on the screen on the player's client system 4 in the form of clickable areas, and the player casts a “vote” for a given result each time he clicks on it, while the player's bet increases for each click. Alternatively, the player may indicate the weight (bet) he will give his vote. Information will then be transmitted to the game system 1, which records the player's bet in the storage device 2 while information is transmitted to the game engine on how many “votes” the player has cast in favour of the outcome concerned. The device 14 for generating an outcome will add up all the “votes” cast for the respective outcome. How the outcome generator 14 generates the outcome on the basis of the players' actions will depend on which game is being implemented. One possibility is to generate a random outcome based on a distribution of probability that reflects the “votes” cast, while another alternative is to simply select the outcome that has obtained the highest total in the registration of the players' actions.

By means of the game engine according to the invention it will be possible to let the players increase their bets on a given number, and also to alter their strategy by changing to betting on another number as long as the round is in progress. This is achieved by the game engine being capable of registering bets or “votes” for the entire duration of the round. It will also be possible, again dependent on which game has to be implemented, to send information back to the players about which outcome at any time stands a good chance of being the final outcome. This can be implemented by only indicating which outcome has attained most “votes”, i.e. on which outcome most bets have been placed, or more detailed information may be given on how large a bet has been placed on each of the possible outcomes. This information may, for example, be transmitted to the respective client systems 4 by means of TCP/IP and HTTP, in the form of HTML. These protocols are well known to those skilled in the art, who will also appreciate that it is possible to use other protocols and formatting of the information.

The game engine will also comprise a device 16, which modifies the generated starting positions as a result of the generated outcome of a round. This may be a module which transmits the generated outcome to the game system 1, or which has direct access to the storage device 2 with the database concerning game information. In a preferred embodiment the game engine is designed to be able to transmit the generated result to the game system 1, whereupon the latter administers the result by registering the outcome in the storage device 2 and implementing the results according to the rules of the ongoing game.

The game engine as described above will preferably be implemented in the form of software modules on a computer, where the software modules comprise instructions that enable the computer to execute those functions specified for the respective devices or modules covered by the game engine. The devices or modules described above will therefore preferably be composed of a combination of program instructions and hardware. However, it will also be possible to implement the whole or parts of the game engine in software.

Those skilled in the art will appreciate that the game engine may be implemented on an isolated computer that is connected to the computer or computers, which form the rest of the game system 1, or the game engine may be implemented on the same computer. From a purely administrative point of view the game engine will preferably act as a subsystem of the game system 1, thereby forming part thereof. Purely from the programming point of view, therefore, the various modules that form the game engine and the various parts of the rest of the game system 1 will be more or less integrated. If it is not desirable to have the capability of implementing different games by means of the game engine, with the result that all administrative tasks will always be the same, the game engine may advantageously be completely integrated in the game system 1.

The method and the game engine according to the invention are particularly suitable for games that have to be realised over large geographical areas, for example by means of the Internet or other communication systems. However, it will be obvious that the invention can also be implemented in a geographically relatively restricted area, for example in premises of the size of a casino or a bingo hall. In this case a plurality of terminals connected to form a network may constitute the player terminals 4, while a central server constitutes the game system 1 with game engine and database 2.

It will also be possible to employ other communication channels than the Internet or other data networks. For example, the player's terminal may be a mobile telephone, and the players' actions may be to send text messages (SMS) to a given number. The player will then be identified by means of his/her telephone number, in which case the form of the player ticket representing the player's starting position will have to be adapted to the display facilities existing on such terminals. For example, the player ticket may comprise only a row of numbers, where those players advance to the next round who have the round's number (outcome) on the relevant number in the row of numbers.

It should also be understood that the communication from players to game system and communication from game system to players does not need to follow the same channel. For example, the players may indicate their actions via the Internet, mobile telephone, telephone or the like, while the results are broadcast, for example, in the form of television programs or text TV.

1. A game engine for supporting the implementation of a game with a plurality of players, wherein the game engine is connected to or forms part of a central computer-based game system (1), which in turn is connected to a data network (3), thus enabling it to exchange information with client systems (4) employed by the participating players,
characterised in that the game engine is designed to receive and transmit information to the other parts of the central game system and/or client systems, where the game engine comprises a device for generating starting positions for a game, where these starting positions may be common to all the players, unique to all the players, or random, but not unique, to all the players; a device for registering starting positions for an ongoing game and, if these are not common to all the players, to associate each player's starting positions with the respective player; a device for receiving information indicating actions performed by the respective players and, on the basis of the total incoming information on the players' actions during a round, to generate an outcome that represents a result for the round concerned and transmit information on this; together with a device for modifying the generated starting positions as a result of the generated outcome and transmit information on this.

2. A game engine according to claim 1,
characterised in that the device for generating starting positions is a random generator, which generates random numbers that are entered in a form, thereby representing a starting position, where such a form may be a common starting position for all the players, or each such form may be associated with an individual player.

3. A game engine according to claim 1,
characterised in that the device for registering starting positions for an ongoing game is a module that transmits generated starting positions to a computer-based game system (1) for storing these starting positions in a storage device (2) in a manner that associates the starting position with an ongoing game and/or with a player's identity.

4. A game engine according to claim 1,
characterised in that the device for receiving information and generating outcome comprises a summing device designed to add up the number of player actions that can be associated with each possible outcome, and an outcome generator designed to generate a given outcome based on the result of this summation.

5. A game engine according to claim 1,
characterised in that the device for receiving information and generating outcome comprises a summing device designed to add up the number of player actions that can be associated with each possible outcome, and an outcome generator designed to generate in the game's introductory rounds a given outcome based on the result of this summation, and in the game's concluding rounds to generate a quasi-random outcome.

6. A game engine according to claim 4 or 5,
characterised in that the summing device is also designed to take account at each summation of weighting factors linked to each individual action.

7. A game engine according to claim 4 or 5,
characterised in that the outcome generator is also designed, on generation of a given outcome, to select the outcome that has achieved the highest total in the said summation.

8. A game engine according to claim 4 or 5,
characterised in that the outcome generator is also designed, on generation of a given outcome, to assign to each possible outcome a probability based on the summation of actions associated with the respective outcomes and generate an outcome based on this distribution of probability.

9. A game engine according to claim 1,
characterised in that the device for modifying the generated starting positions is a module that transmits the generated outcome to a data-based game system (1) for updating of the registered starting positions in a manner that reflects the generated outcome.

10. A game engine according to one of the preceding claims,
characterised in that it is composed of a combination of software modules in a computer.

11. A method for supporting in a computer-based system the implementation of a game with a plurality of participants, where the computer-based system is connected to a data network for exchanging information between the system and client systems employed by the participating players,
characterised in that it comprises the following steps;
generating game information (201) representing the starting position for the game and transmitting this (202) via a communication interface to the respective client systems,
receiving via the said communication network messages containing information (203) on the players' influence on the game in the form of a specific desired outcome and a specific bet linked to the outcome, in addition to identifying the player, where no, one or a plurality of such messages may be received from each player,
continuously registering for each possible outcome accumulated values (204) representing the total bet associated with each said possible outcome,
at a predetermined time representing the conclusion of a round of the game, generating an outcome (205) among the possible outcomes based on the said accumulated values, and registering the generated outcome as well as any changes in the generated starting positions as a result of the outcome,
if more rounds of the ongoing game remain, repeating the above steps until no more such rounds remain, and
generating a final result of the game by evaluating the total registered changes in the respective starting positions on the basis of the rules applying to the ongoing game and implementing the consequences of the results as a final result (211) for the game.

12. A method according to claim 10,
characterised in that the step of generating game information (201) representing a starting position consists in employing a random generator, which generates random numbers, and entering these numbers in a form representing the said starting position, where such a form may be a common starting position for all the players, or each such form may be associated with an individual player.

13. A method according to claim 10,
characterised in that the step of generating play information (201) representing a starting position is followed by a step for transmitting said starting positions to a computer-based game system (1) for storing in a storage device (2) in a manner that associates the starting position with an ongoing game and/or with a player's identity.

14. A method according to claim 10,
characterised in that the step of generating an outcome (205) consists in selecting the outcome that has achieved the highest total in the said summation.

15. A method according to claim 10,
characterised in that the step of generating an outcome (205) consists in assigning to each possible outcome a probability that is based on the summation of actions associated with the respective outcomes and generating an outcome based on this distribution of probability.

16. A method according to claim 10,
characterised in that the step of generating an outcome (205) in the game's introductory rounds consists in selecting an outcome based on the said summation, and in the game's concluding rounds consists in generating a quasi-random outcome.

17. A method according to claim 10,
characterised in that the communication via the said data network is supplemented by communication via other communication channels.

18. A computer program which, when installed in a data system, enables the system to execute the method according to one of the claims 10 to 14.

19. A computer program according to claim 16, stored on a storage medium that can be read by a computer.

20. A computer program according to claim 17, where the said storage medium is an optical or magnetic storage medium such as a CD-ROM, DVD or hard disc.
